(19) United States
(12) Patent Application Publication
(10) Pub. No.: US 2026/0140559 A1
(43) Pub. Date: May 21, 2026

(54) POWER INFORMATION COMMUNICATION METHOD AND SYSTEM, AND ELECTRONIC DEVICE AND STORAGE MEDIUM

(71) Applicant: Suzhou MetaBrain Intelligent Technology Co., Ltd., Suzhou, Jiangsu (CN)

(72) Inventor: Mingwei WU, Suzhou, Jiangsu (CN)

(21) Appl. No.: 19/142,750

(22) PCT Filed: Apr. 22, 2024
(86) PCT No.: PCT/CN2024/089146

§ 371 Date: Jun. 24, 2025

(30) Foreign Application Priority Data
Nov. 23, 2023 (CN) 202311570979.1

(51) Int. Cl. G06F 1/324; G06F 1/28; G06F 13/42

(52) U.S. Cl. CPC G06F 1/324; G06F 1/28; G06F 13/4282; G06F 2213/0016

(57) ABSTRACT

The present application provides a power information communication method and system, and an electronic device and a storage medium, applied to a first switch and a second switch. The first switch includes a first clock line switch and a first data line switch. The second switch includes a second clock line switch and a second data line switch. The method includes: in response to receiving an access request transmitted by a baseboard management controller through a first serial communication bus, returning response information to the baseboard management controller through the first serial communication bus; determining, according to a polling cycle set by a user, whether a working communication with the baseboard management controller is abnormal; and restoring the communication with the baseboard management controller through one of the first serial communication bus and a second serial communication bus, and one of the first switch and the second switch.

### CROSS-REFERENCE TO RELATED APPLICATION

This application claims priority to Chinese Patent Application No. 202311570979.1, entitled “POWER INFORMATION COMMUNICATION METHOD AND SYSTEM, AND ELECTRONIC DEVICE AND STORAGE MEDIUM”, filed with the China National Intellectual Property Administration on Nov. 23, 2023, which is incorporated by reference in its entirety.

### FIELD

The present application relates to a power information communication method and system, and an electronic device and a storage medium.

### BACKGROUND

A server system needs to read various parameters from a server power supply unit (Server PSU) at any time for power management and system optimization. Read content might be classified into a voltage parameter, a current parameter, a temperature parameter, a power parameter, a fan speed, and the like. A server uses a baseboard management controller (BMC) to access the Server PSU through an inter-integrated circuit (I2C) bus (which is a hardware layer), and obtains various readings from the Server PSU through an intelligent platform management interface (IPMI) instruction set (which is a software layer) by using a power management bus 1.2 (PMBus 1.2) specification. FIG. 1 shows an architecture diagram of communication between the Server PSU and the BMC of the server. There will be many elements waiting to communicate with the BMC on the I2C Bus, and BMC might distinguish elements to be accessed through different addresses. On average, an access is conducted every 10 milliseconds to 2 seconds (depending on round-robin time of the I2C Bus of the system) to obtain desired information. I2C Bus communication is bidirectional and might obtain a reply only if an element sends an instruction. However, if neither party (the PSU or the BMC) sends an access command, the PSU will continue to wait for an instruction. The BMC will also wait for a reply of the PSU and will not send a next command because it has not received a reply from the PSU. In this case, this phenomenon might be referred to as Server PSU and BMC communication failure. In this case, the BMC will also sound an alarm due to an inability of obtaining various parameter readings of the Server PSU.

### SUMMARY

According to an embodiment of the present application, in a first aspect, a power information communication method is provided, which is applied to at least one server power supply unit. The at least one server power supply unit includes a first switch and a second switch. The first switch includes a first clock line switch and a first data line switch. The second switch includes a second clock line switch and a second data line switch. The method includes:
in response to receiving an access request transmitted by a baseboard management controller through a first serial communication bus, returning response information to the baseboard management controller through the first serial communication bus, where the first serial communication bus includes a first data line and a first clock line;
determining, according to a polling cycle set by a user, whether a working communication with the baseboard management controller is abnormal; and
in response to an abnormal working communication with the baseboard management controller, restoring the communication with the baseboard management controller through one of the first serial communication bus and a second serial communication bus, and one of the first switch and the second switch, where the second serial communication bus includes a second data line and a second clock line; the first clock line and the second clock line are connected in parallel to each other; and the first data line and the second data line are connected in parallel to each other.

According to an embodiment of the present application, in a second aspect, a power information communication method applied to a power information communication system is further provided. The method includes:
in response to receiving a query instruction transmitted by a server system, determining, by a baseboard management controller, at least one server power supply unit according to the query instruction, and transmitting an access request to the at least one server power supply unit through a first serial communication bus;
in response to receiving the access request transmitted by the baseboard management controller through the first serial communication bus, returning, by the at least one server power supply unit, response information to the baseboard management controller through the first serial communication bus, where the first serial communication bus includes a first data line and a first clock line, and the at least one server power supply unit includes a group of first switches and a group of second switches;
determining, according to a polling cycle set by a user by the at least one server power supply unit, whether a working communication with the baseboard management controller is abnormal; and
in response to an abnormal working communication with the baseboard management controller, restoring, by the at least one server power supply unit and the baseboard management controller, communication through one of the first serial communication bus and a second serial communication bus, and one of the group of first switches and the group of second switches, where the second serial communication bus includes a second data line and a second clock line; the first clock line and the second clock line are connected in parallel to each other, and the first data line and the second data line are connected in parallel to each other.

According to an embodiment of the present application, in a third aspect, a power information communication system is further provided, which is characterized by including a baseboard management controller, at least one server power supply unit, a first serial communication bus, and a second serial communication bus.

Each of the at least one server power supply includes a group of first switches and a group of second switches, and the baseboard management controller includes a group of third switches.

Working communication is performed between the baseboard management controller and the at least one server power supply through the first serial communication bus, the third switches, and the first switches; working communication is performed between the baseboard management controller and the at least one server power supply unit through the second serial communication bus, the third switches, and the first switches; exchange bilateral bidirectional communication is performed between the baseboard management controller and the at least one server power supply unit through the second serial communication bus, the third switches, and the second switches; the first serial communication bus includes a first data line and a first clock line; the second serial communication bus includes a second data line and a second clock line; the first clock line and the second clock line are connected in parallel to each other; and the first data line and the second data line are connected in parallel to each other.

According to an embodiment of the present application, in a fourth aspect, a computer device is further provided, which includes a memory, a processor, and a computer-readable instruction stored on the memory and executable on the processor. The processor, when executing the computer-readable instruction, implements the method according to any embodiment of the first aspect and the second aspect.

According to an embodiment of the present application, in a fifth aspect, a non-transitory computer-readable storage medium is further provided, having a computer-readable instruction stored thereon. The computer-readable instruction, when executed by a processor, implements the method according to any embodiment of the first aspect and the second aspect.

The details of one or more embodiments of the present application are presented in the accompanying drawings and description below. Other features and advantages of the present application will become apparent from the specification, accompanying drawings, and claims.

### BRIEF DESCRIPTION OF THE DRAWINGS

To describe the technical solutions in the embodiments of the present application or in the related art more clearly, the following briefly introduces the accompanying drawings for describing the embodiments or the related art. Apparently, the accompanying drawings in the following description show merely the embodiments of the present application, and a person of ordinary skill in the art may still derive other drawings from the provided accompanying drawings without creative efforts.

FIG. 1 is a schematic topological diagram of a device interaction system of a server system according to one or more embodiments of the present application;

FIG. 2 is a schematic communication diagram for a single PSU and a BMC system during working communication according to one or more embodiments of the present application;

FIG. 3 is a conventional communication architecture diagram of interaction between a BMC and a PSU according to one or more embodiments of the present application;

FIG. 4 is a schematic diagram of steps of a device communication method of a server according to one or more embodiments of the present application;

FIG. 5 is a schematic topological diagram of a conventional server system according to one or more embodiments of the present application;

FIG. 6 is an example diagram of a signal waveform of normal communication of I2C bus according to one or more embodiments of the present application;

FIG. 7 is a communication architecture diagram of normal interaction between a single PSU and a BMC according to one or more embodiments of the present application;

FIG. 8 is a communication architecture diagram of normal interaction between a plurality of PSUs and a BMC according to one or more embodiments of the present application;

FIG. 9 is an example diagram of a signal waveform of a communication failure between a BMC and a PSU according to one or more embodiments of the present application;

FIG. 10 is a communication architecture diagram of an I2C bus that includes a serial connection element according to one or more embodiments of the present application;

FIG. 11 is a communication architecture diagram of an I2C bus that includes a plurality of I2C devices according to one or more embodiments of the present application;

FIG. 12 is an example flowchart of a device communication method of a server according to one or more embodiments of the present application;

FIG. 13 is an example diagram of a signal waveform of restored normal communication between a PSU and a BMC according to one or more embodiments of the present application;

FIG. 14 is a communication architecture diagram of a digital Server PSU according to one or more embodiments of the present application;

FIG. 15 is a schematic communication diagram for a single PSU and a BMC system during exchange bilateral bidirectional communication according to one or more embodiments of the present application;

FIG. 16 is a communication architecture diagram for a single PSU and a BMC system during exchange bilateral bidirectional communication according to one or more embodiments of the present application;

FIG. 17 is a communication architecture diagram for a plurality of PSUs and a BMC system during exchange bilateral bidirectional communication according to one or more embodiments of the present application;

FIG. 18 is a communication architecture diagram for a plurality of PSUs and a BMC system in a bilateral bidirectional communication according to one or more embodiments of the present application;

FIG. 19 is an instruction set example diagram of a PMB1.2 instruction set according to one or more embodiments of the present application;

FIG. 20 is a schematic instruction set diagram of an I2C bus state instruction set according to one or more embodiments of the present application;

FIG. 21 is a diagram of an internal structure of a computer device according to one or more embodiments of the present application; and

FIG. 22 is a schematic structural diagram of a non-transitory computer-readable storage medium according to one or more embodiments of the present application.

### DETAILED DESCRIPTION

In order to make the objectives, technical solutions, and advantages of the present application clearer, the following is a further detailed explanation of the present application in conjunction with the accompanying drawings and embodiments. It should be understood that the specific embodiments described herein are merely used to explain the present application but are not intended to limit the present application.

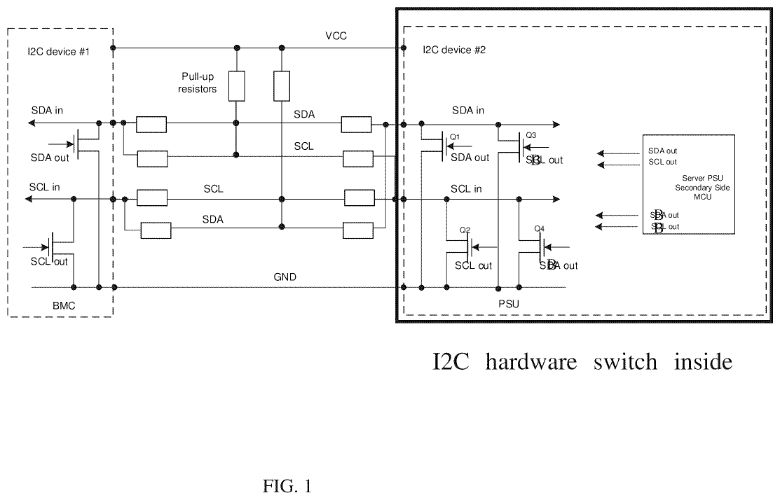

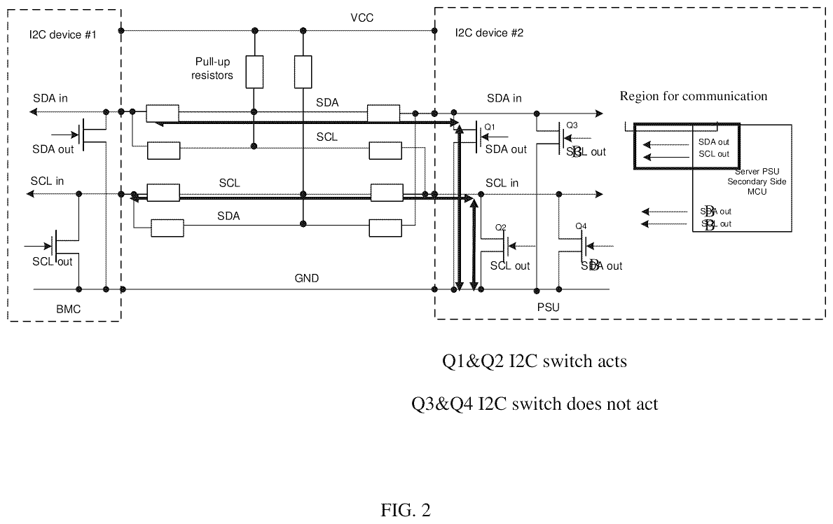

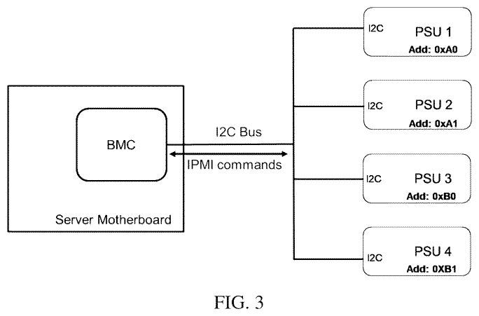

A topological diagram of a system of the present application is shown in FIG. 1. The system includes a BMC, at least one PSU, and an I2C Bus. A communication function of the I2C Bus is mainly implemented through four signal lines: a serial data line (SDA), a serial clock line (SCL), a voltage to current converter (VCC), and a ground (GND). (1) VCC is a power supply unit. (2) SDA is a serial data line for transmitting data. (3) SCL is serial clock line for transmitting a clock sequence. (4) GND is a ground line. Different from the existing art, the system includes two SDAs (a first data line and a second data line) and two SCLs (a first clock line and a second clock line). It might be considered that in the figure, the upper SDA in the figure is the first data line, and the lower SDA is the second data line; and the upper SCL is the first clock line, and the lower SCL is the second clock line. The two SDAs are connected in parallel to each other, and the two SCLs are connected in parallel to each other. In addition, Q₁SDA out (a first data line switch), Q₂SCL out (a first clock line switch), a Q₃SCL′ out (a second clock line switch), and Q₄SDA′ out (a second data line switch) are arranged in the PSU, where Q₁ and Q₃ are respectively connected in series with the first data line, certainly, which is equivalent to being connected in series with the second data line; and Q₂ and Q₄ are respectively connected in series with the first clock line, certainly, which is also equivalent to being connected in series with the second clock line. In a normal communication between the BMC and the PSU, as shown in FIG. 2, an I2C communication between the BMC and the PSU is completed through the first data line, the first clock line, and closing or opening actions of Q₁ and Q₂. In addition, FIG. 3 shows a communication architecture between a BMC and a PSU. A server system requires a power supply unit to have a redundancy function, so there are two or more Server PSUs in the system. There may be many elements waiting to communicate with BMC on an I2C Bus, and BMC may distinguish elements to be accessed by different addresses.

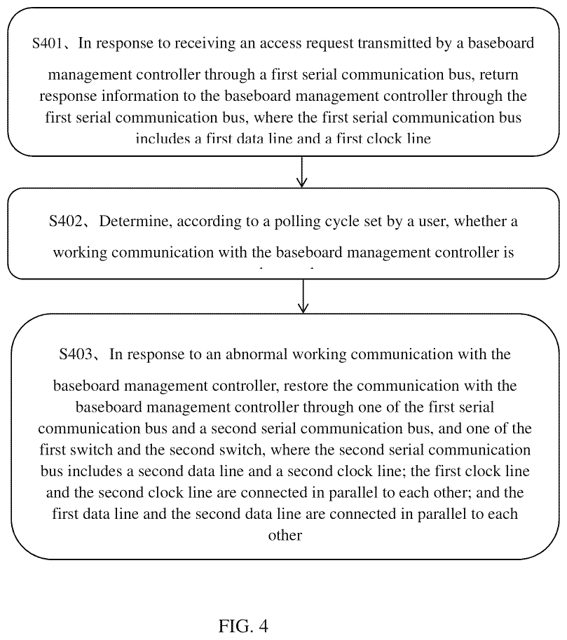

In some embodiments, as shown in FIG. 4, the present application provides a power information communication method, applied to at least one server power supply unit. The at least one server power supply unit includes a first switch and a second switch. The first switch includes a first clock line switch and a first data line switch. The second switch includes a second clock line switch and a second data line switch. The method includes:
S401: In response to receiving an access request transmitted by a baseboard management controller through a first serial communication bus, returning response information to the baseboard management controller through the first serial communication bus, where the first serial communication bus includes a first data line and a first clock line.
S402: Determining, according to a polling cycle set by a user, whether a working communication with the baseboard management controller is abnormal.
S403: If the working communication with the baseboard management controller is abnormal, in response to an abnormal working communication with the baseboard management controller, restoring the communication with the baseboard management controller through one of the first serial communication bus and a second serial communication bus, and one of the first switch and the second switch, where the second serial communication bus includes a second data line and a second clock line; the first clock line and the second clock line are connected in parallel to each other; and the first data line and the second data line are connected in parallel to each other.

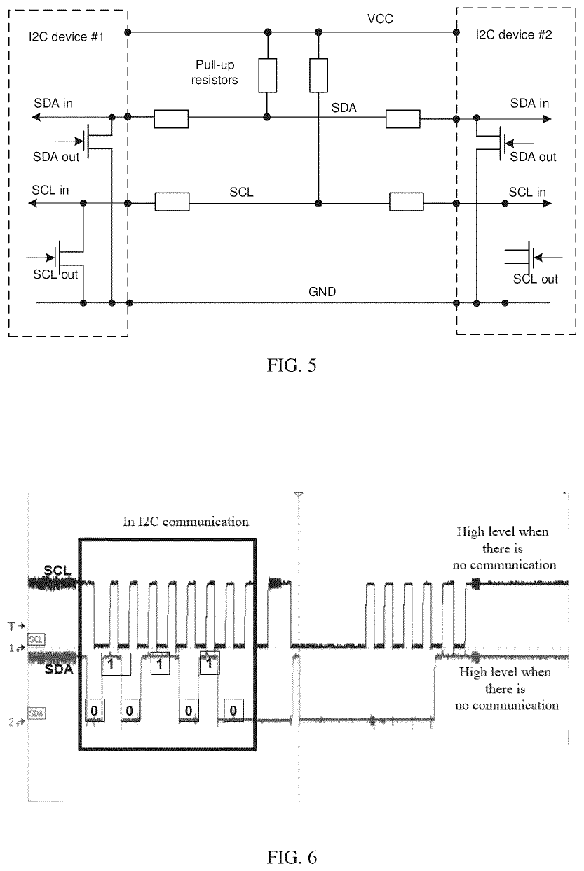

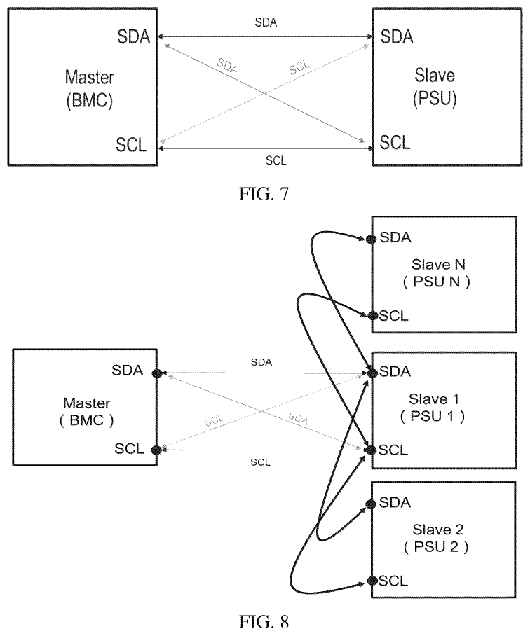

In some embodiments, when a query instruction transmitted by an upstream device has been received, a BMC in a communication system transmits an access request to one or more PSUs, to obtain power information of each corresponding PSU. If the communication system is not abnormal, at least one PSU receives the access request and returns response information to the BMC through an I2C Bus (which is the first serial communication bus) that includes an SDA and an SCL. FIG. 5 shows an architecture diagram of a conventional communication hardware layer of the I2C Bus. When there is no instruction transmission at ordinary times, both the SDA and the SCL are at high levels. During communication, a signal that indicates pulling down the high level to a low level of 0 is transmitted. By comparing FIG. 1 with FIG. 5, it might be seen that compared with a conventional technology, the present application requires creation of an additional SDA and an additional SCL based on the original I2C bus, and a clock line switch Q₃, and a data line switch Q₄ need to be added in at least one PSU device. Referring to a signal waveform during I2C Bus communication in FIG. 6, it might be seen that the SDA/SCL remains at a continuous high level when no communication is performed. A continuous 0/1 signal may be generated when a communication begins. In the Server PSU, a microcontroller unit (MCU) in the Server PSU controls Q₁ corresponding to the SDA and Q₂ corresponding to the SCL to complete I2C communication. FIG. 7 is a simple communication architecture diagram of a normal communication between a single PSU and a BMC in a system. FIG. 8 is a simple communication architecture diagram of a normal communication between a plurality of PSUs and a BMC in a system.

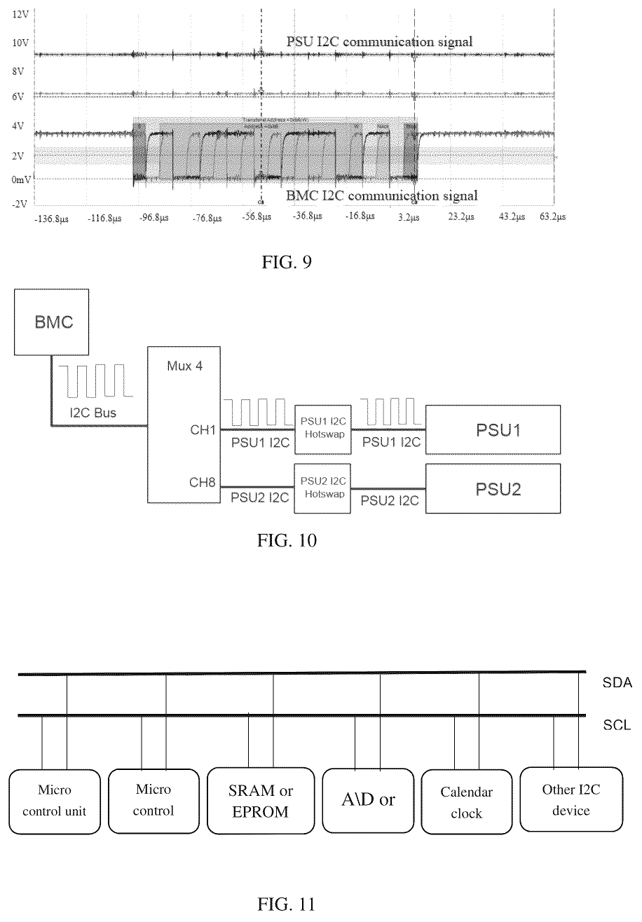

During this period, the PSU may determine, within each polling cycle, whether a working communication with the BMC is abnormal. FIG. 9 is a waveform of a communication failure between a server power supply unit and a BMC. From the waveform, it might be seen that a BMC I2C communication signal is transmitted, and a PSU I2C communication signal still continues to maintain a high level without any change or feedback. In this case, this is referred to as PSU and BMC communication failure, i.e., abnormality.

In some embodiments, the determining, according to a polling cycle set by a user, whether a working communication with the baseboard management controller is abnormal includes:
in response to monitoring that a pin level of the first data line and a pin level of the first clock line are both high levels, determining whether the access request is received within the polling cycle;
if the access request is received within the polling cycle, returning the response information to the baseboard management controller through the first serial communication bus; and
if the access request is not received within the polling cycle, determining that the working communication is abnormal.

In some embodiments, for the determination of the communication failure between the Server PSU and the BMC, refer mainly to two aspects: (1) whether pin levels corresponding to SDA and SCL remain at VCC (a high level); and (2) whether the Server PSU receives an I2C signal from the BMC within the polling cycle (e.g. 10 ms to 2 S). The polling period may be set through the BMC, with a minimum of 10 milliseconds and a maximum of 2 seconds. When it is determined that the pin level corresponding to the I2C Bus remains at a high level and the Server PSU does not receive the I2C signal of the access request transmitted by the BMC within the polling cycle, it indicates that there is a communication failure, namely, an abnormality, between the Server PSU and the BMC. In case of the communication failure, there may be two possible reasons for the communication failure: (1) Due to low sink capability of an I2C switch, the switch might not be pulled down to achieve switching between a low level and a high level, whereby the communication fails. A specific reason may be excessively high capacitive reactance of a serially connected element on an I2C bus path (the first serial communication bus). (2) Deadlock is caused by a plurality of I2C devices on an I2C Bus communication route. FIG. 10 is a communication architecture diagram showing that there is a serially connected element on an I2C path. The reason of the communication failure caused by the fact that switching between a high level and a low level might not be implemented may be system I2C topology and address avoidance. A Mux selector switch chip and an I2C hotswap chip that may be used to support communication hot swap may be usually used. Therefore, the problem of excessive capacitive reactance of the serially connected element on the I2C path easily occurs on the I2C Bus path. In addition, when the server system works in low-and high-temperature environments, if some chips work in low-and high-temperature environments, a physical characteristic of a semiconductor device may change due to a temperature drift, whereby internal stray capacitance may increase. Therefore, the I2C switch requires excessively high pull-down current, making it difficult to smoothly pull down the I2C signal to a low level. As shown in FIG. 11, a plurality of I2C devices may cause a deadlock in the I2C Bus communication route. The plurality of I2C devices not only cause the deadlock due to abnormal resetting, but also lead to mutual interference. Generally, the same slaver address may not be hung on the same bus, but in addition, some I2C devices are not designed according to a standard I2C bus protocol. While sharing the I2C bus, some devices may transmit a response only if there is a slaver address on the bus. In this way, due to an error response of a slaver, namely, after the BMC transmits an access request, a plurality of devices may return response information at the same time, and a plurality of clock signals and a plurality of data signals on a serial communication bus make the I2C bus abnormal, and even clamp the bus, causing the I2C bus to enter a deadlock state. In this case, the communication between the server power supply unit and the BMC fails. Since the BMC does not successfully receive the response information, the BMC always waits to receive the response information and will not transmit the access request again. In addition, an alarm is generated since it might not obtain readings of various parameters of the Server PSU, and a timely state of the server power supply unit might not be obtained. If there is really a fault in the server power supply unit, maintenance personnel might not be informed in time, which may further cause a risk of the server system being offline.

In some embodiments, the restoring the communication with the baseboard management controller through one of the first serial communication bus and a second serial communication bus, and one of the first switch and the second switch includes:
attempting to restore the working communication through the first serial communication bus, the first data line switch corresponding to the first data line, and the first clock line switch corresponding to the first clock line;
in response to a failure of attempting to restore the working communication through the first serial communication bus, the first data line switch, and the first clock line switch, attempting to restore the working communication through the second serial communication bus, the first data line switch, and the first clock line switch; and
in response to a failure of attempting to restore the working communication through the second serial communication bus, the first data line switch, and the first clock line switch, performing exchange bilateral bidirectional communication with the baseboard management controller through the second serial communication bus, the second data line switch, and the second clock line switch.

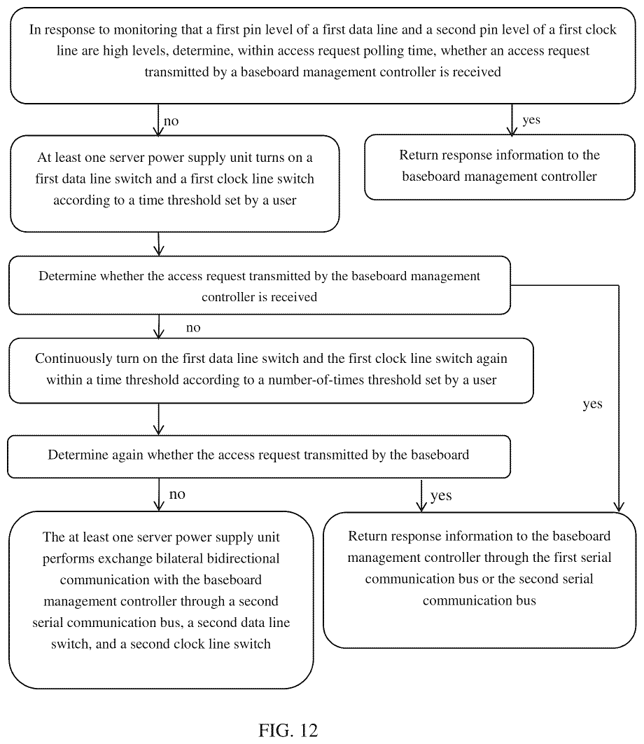

In some embodiments, as shown in FIG. 12, after it is determined that the communication failure occurs, the PSU might attempt to restore the working communication with the BMC for many times through the first serial communication bus and internal Q₁ and Q₂, where a number-of-times threshold is set by a user, for example, three times. If the communication is not restored after three attempts, the PSU may then attempt to restore the working communication with the BMC for many times through the second serial communication bus and internal Q₁ and Q₂. Similarly, after the plurality of attempts, the communication has not been restored, since the restoration of the working communication fails through the above operation, it indicates that the communication failure is not caused by reason (1). In this case, exchange bilateral bidirectional communication is implemented through the second serial communication bus and internal Q₃ and Q₄.

In some embodiments, the attempting to restore the working communication through the first serial communication bus, the first data line switch, and the first clock line switch includes:
turning on the first data line switch according to a time threshold set by the user to continuously pull down a pin level of the first data line to a low level, and turning on the first clock line switch to continuously pull down a pin level of the first clock line to a low level;
determining whether the access request transmitted by the baseboard management controller is received through the first serial communication bus within the polling cycle;
if the access request is received within the polling cycle, returning the response information to the baseboard management controller through the first serial communication bus; and
if the access request is not received within the polling cycle, continuing to attempt to restore the working communication according to a number-of-times threshold and the first serial communication bus.

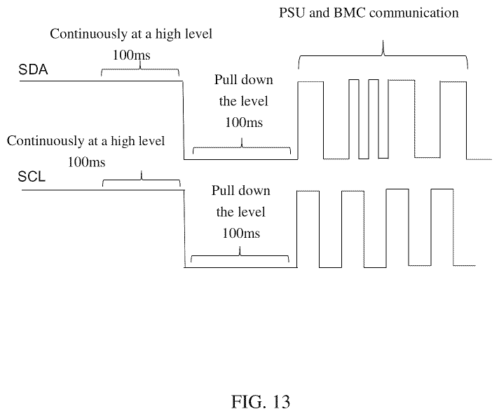

In some embodiments, since it is uncertain at the beginning what has caused the communication failure, the PSU first turns on two I2C switches (the first clock line switch and the first data line switch) to make the two I2C switches grounded continuously to achieve a function that the I2C bus is continuously at a low level. That is, the two pin levels of the first SDA and the first SCL in a hardware layer are simultaneously pulled to a low level (0 V) for continuous 100 ms (the time threshold may be set by a user). If the working communication is successfully restored, as shown in FIG. 13, it might be learned through the signal waveform returned to BMC through the Server PSU that the normal communication with the BMC is restored, and it is determined that excessively high capacitive reactance of a serially connected element on the first serial communication bus causes low sink capability of the I2C switch, whereby the switch might not be pulled down to achieve switching between a low level and a high level, and the abnormality has been restored. If the communication abnormality is caused by reason (1), it attempts to repair the capacitive reactance of the first serial communication bus by continuously pulling down the level to restart the line. If the communication is not successfully restored on the first attempt, it might continue to attempt to perform the above operation according to the number-of-times threshold set by the user, such as for three times. If the normal communication is still not restored after three attempts, a plurality of attempts may be made to restore the working communication with the BMC through the second serial communication bus and internal Q₁ and Q₂.

In some embodiments, the returning the response information to the baseboard management controller through the first serial communication bus includes:
returning a clock signal corresponding to the response information through the first clock line in the first serial communication bus and the first clock line switch; and
returning a data signal corresponding to the response information through the first data line in the first serial communication bus and the first data line switch.

In some embodiments, after the communication is restored successfully through the above operation, the PSU uses the first SDA and controls Q₁ to act to return a data signal to the BMC, and uses the first SCL and controls Q₂ to act to return a clock signal to the BMC.

In some embodiments, the reattempting to restore the working communication through the second serial communication bus, the first data line switch, and the first clock line switch includes:
turning on the first data line switch according to a time threshold to continuously pull down a pin level of the second data line to a low level, and turning on the first clock line switch to continuously pull down a pin level of the second clock line to a low level;
determining whether the access request transmitted by the baseboard management controller is received through the second serial communication bus within the polling cycle;
if the access request is received within the polling cycle, returning the response information to the baseboard management controller through the second serial communication bus; and
if the access request is not received within the polling cycle, continuing to attempt to restore the working communication according to a number-of-times threshold and the second serial communication bus.

In some embodiments, the PSU first turns on Q₁ and Q₂ to simultaneously pull the two pin levels of the second SDA and the second SCL to a low level (0 V) for continuous 100 ms (the time threshold may be set by a user). Due to the parallel connection, the pin levels of the two SDAs are the same, and the pin levels of the two SCLs are the same. Afterwards, if the I2C signal transmitted by the BMC is successfully received through the second serial communication bus and a corresponding I2C is returned to the BMC, it indicates that the communication between the BMC and the PSU is normal, and it also indicates that the abnormality, such as excessively high capacitive reactance, of the first serial communication bus might not be repaired. Certainly, if the communication is not successfully restored on the first attempt, the communication may be continued to be restored according to the number-of-times threshold set by the user, such as for three times. If the normal communication is still not restored after the same operation is performed for three times, it is determined that the communication failure is not caused by the following reason: the excessively high capacitive reactance of the serially connected element on the I2C bus path causes low sink capability of the I2C switch, whereby the switch might not be pulled down to achieve switching between a low level and a high level. In this case, it is determined that the communication failure is caused by reason (2).

In some embodiments, the returning the response information to the baseboard management controller through the second serial communication bus includes:
returning a clock signal corresponding to the response information through the second clock line in the second serial communication bus and the first clock line switch; and
returning a data signal corresponding to the response information through the second data line in the second serial communication bus and the first data line switch.

In some embodiments, after the communication is restored successfully through the above operation, the PSU uses the second SDA and controls Q₁ to act to return a data signal to the BMC, and uses the second SCL and controls Q₂ to act to return a clock signal to the BMC.

In some embodiments, the performing exchange bilateral bidirectional communication with the baseboard management controller through the second serial communication bus, the second data line switch, and the second clock line switch includes:
turning on the second data line switch according to a time threshold to continuously pull down a pin level of the second clock line to a low level, and turning on the second clock line switch to continuously pull down a pin level of the second data line to a low level; and
in response to receiving the access request transmitted by the baseboard management controller, returning response information to the baseboard management controller through the second serial communication bus, the second data line switch, and the second clock line switch.

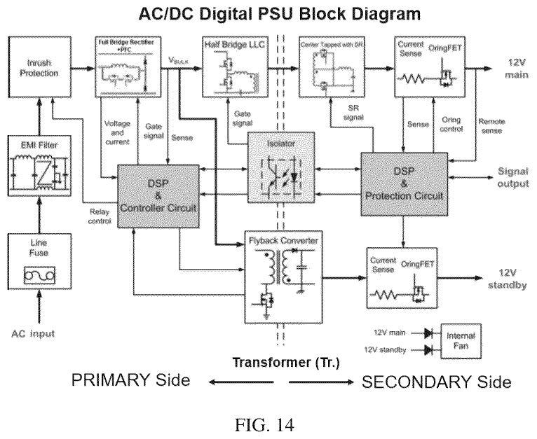

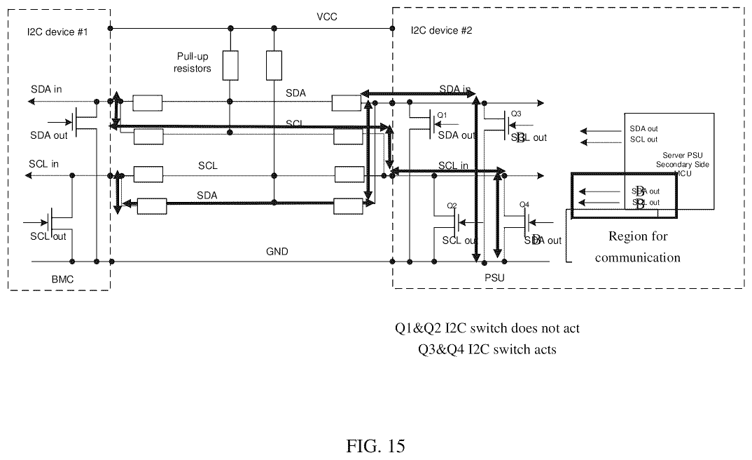

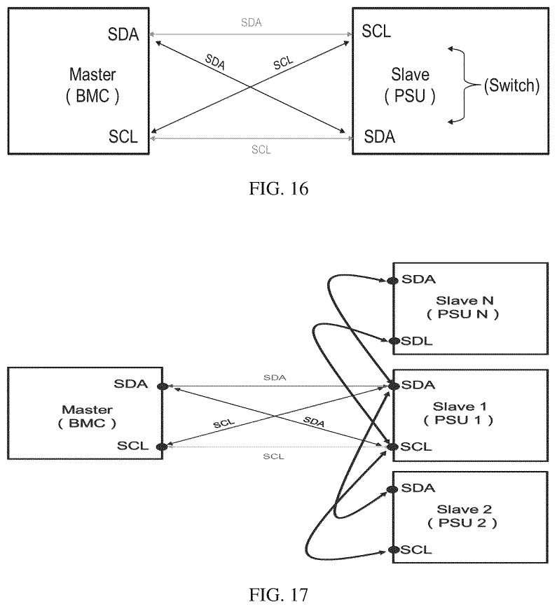

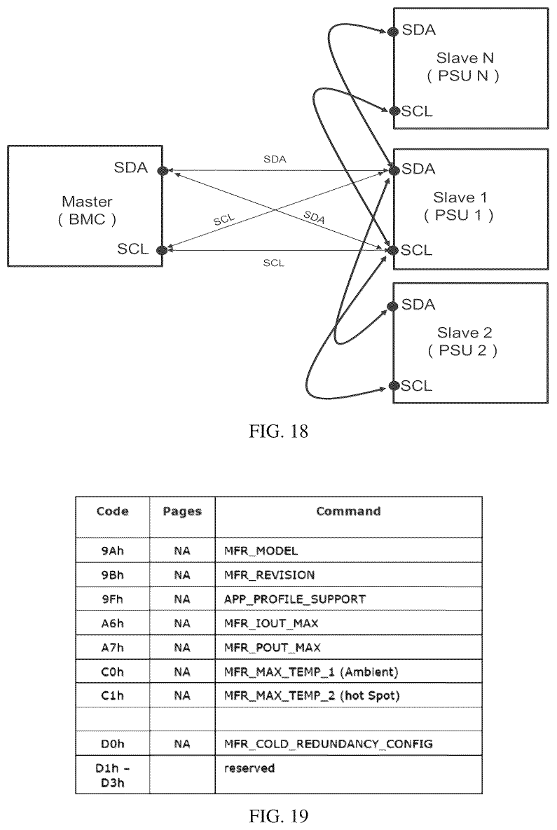

In some embodiments, FIG. 14 is an internal architecture diagram of a digital Server PSU. Currently, the Server PSU is controlled by an MCU to complete functions such as converter on/off control, fan control, LED control, monitoring, protection, and communication in the power supply unit. In terms of division of labor, it may be divided into a PRIMARY Side MCU and a SECONDARY Side MCU. Main external communication functions are controlled and implemented by the SECONDARY Side MCU. FIG. 15 is a schematic communication diagram for a single PSU and a BMC system during exchange bilateral bidirectional communication. The communication failure is caused by reason (2). In this case, the MCU continuously turns on Q₃ and Q₄ to pull the two pin levels of the second SDA and the second SCL to a low level (0 V) for continuous 100 ms (the time threshold may be set by a user), a role similar to restarting a line is played. In this case, the PSU may certainly receive the access request transmitted by the BMC through the second serial communication bus, and then control a group of I2C hardware switches Q₃ and Q₄ to act (be opened or closed) and the second serial communication bus that includes the second SDA and the second SCL to achieve the exchange bilateral bidirectional communication. In this case, the switches Q₁ and Q₂ do not act. In a scenario where the first SDA or the first SCL might not communicate normally, an additional communication path is added to enable a cross communication between a plurality of slavers and a master. This is referred to as exchange bilateral bidirectional communication, thus avoiding the communication failure caused by I2C bus deadlock. FIG. 16 is a communication architecture diagram for a single PSU and a BMC system during exchange bilateral bidirectional communication. FIG. 17 is a communication architecture diagram for a plurality of PSUs and a BMC system during exchange bilateral bidirectional communication. FIG. 18 is a communication architecture diagram for a plurality of PSUs and a BMC system in a bilateral bidirectional communication. In the above solution, if there is an exchange bilateral bidirectional communication between the BMC and the PSU, Q₃ and Q₄ need to exist in each PSU, and the exchange bilateral bidirectional communication may further be used between the BMC and the PSU, that is, the BMC and the PSU communicate through two serial communication buses at the same time. In this case, only one pair of Q₃ and Q₄ needs to exist in one of the PSUs. In response to receiving a bilateral bidirectional communication instruction transmitted by a user, the BMC performs bilateral bidirectional communication with at least one PSU, and the remaining PSUs return response information that includes power information to a target PSU with the pair of Q₃ and Q₄ through the first serial communication bus. Afterwards, the target PSU uses the second serial communication bus and controls Q₃ and Q₄ to act to return the response information of the remaining PSUs to the BMC.

In some embodiments, the returning response information to the baseboard management controller through the second serial communication bus, the second data line switch, and the second clock line switch includes:
returning a data signal corresponding to the response information through the second clock line in the second serial communication bus and the second data line switch; and
returning a clock signal corresponding to the response information through the second data line in the second serial communication bus and the second clock line switch.

In some embodiments, after the communication is restored successfully through the above operation, the PSU uses the second SDA and controls Q₃ to act to return a data signal to the BMC, and uses the second SCL and controls Q₄ to act to return a clock signal to the BMC. Since the I2C signals transmitted by another device may interfere with the communication between the PSU and the BMC, by the exchange bilateral bidirectional communication, the clock signal is returned through the SDA, and the data signal is returned through the SCL, thereby avoiding the interference of the data signal transmitted by another device on the SDA with the clock signal returned by the PSU and avoiding the interference of the clock signal transmitted by another device on the SCL with the data signal returned by the PSU.

In some embodiments, after the returning response information to the baseboard management controller through the second serial communication bus, the second data line switch, and the second clock line switch, the method further includes:
generating communication abnormality information, and transmitting the communication abnormality information to the baseboard management controller through the second serial communication bus, the second data line switch, and the second clock line switch;
in response to receiving a restart instruction transmitted by the baseboard management controller, restarting an input power supply unit according to the restart instruction to turn off the second data line switch and the second clock line switch; and
in response to restarting the input power supply unit, performing the working communication through the first serial communication bus, the first data line switch, and the first clock line switch.

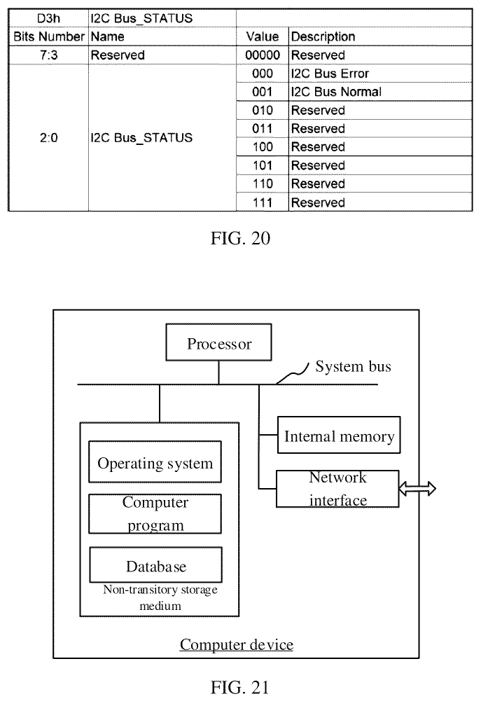

In some embodiments, as shown in FIG. 19, it is an instruction set example diagram of a PMB1.2 instruction set. Information fed back to the BMC might be defined through the PMBus 1.2 specification. D1h-D3h instruction sets in the PMBus1.2 instruction set is reserved for function expansion. FIG. 20 is a schematic instruction set diagram of an I2C bus state instruction set. Function definition and expansion might be performed by using a D3h address. The PSU transmits communication abnormality information that includes the D3h address to the BMC. The BMC alerts the user after receiving the communication abnormality information. The user checks other devices on the bus. Afterwards, when a restart instruction transmitted by the BMC is received, it indicates that the user has checked other devices on the bus and transmitted a normal communication restoration instruction to the BMC. In this case, the Server PSU may restart its input power supply unit. After the restart of the Server PSU succeeds, Q₃ and Q₄ will be automatically opened, causing a link between Q₃ and the second SDA to be broken and a link between Q₄ and the second SCL to be broken. Then, the working communication with the BMC is restored through Q₁ and the corresponding SDA, as well as Q₂ and the corresponding SCL. That is, in the exchange bilateral bidirectional communication mode, the input power supply unit of the Server PSU might also be cut off, and the normal communication path might be restored after the Server PSU is powered on again.

In some embodiments, a power information communication method is further provided, applied to a baseboard management controller. The baseboard management controller includes a third switch. The third switch includes a third clock line switch and a third data line switch. The method includes:
in response to receiving a query instruction transmitted by a server system, determining at least one server power supply unit according to the query instruction, and transmitting an access request to the at least one server power supply unit through a first serial communication bus and the third switch;
in response to receiving response information returned by the at least one server power supply unit through the first serial communication bus, performing working communication with the at least one server power supply unit through the first serial communication bus and the third switch; and
in response to receiving response information returned by the at least one server power supply unit through a second serial communication bus, performing exchange bilateral bidirectional communication or the working communication with the at least one server power supply unit through the second serial communication bus and the third switch.

In some embodiments, according to system requirements, a BMC needs to poll power information of each Server PSU within system polling time. Read content might be classified into a voltage parameter, a current parameter, a temperature parameter, a power parameter, a fan speed, and the like. A server uses the BMC to access a Server PSU through an I2C Bus (hardware layer), and obtains various readings from the Server PSU through the IPMI instruction set (software layer) by using the PMBus1.2 specification. When the BMC transmits an access request to the Server PSU, the BMC transmits a data signal of the access request to the Server PSU through its internal SDA out switch and a first SDA, and transmits a clock signal of the access request to the Server PSU through its internal SCL out switch and a first SCL. When the BMC receives response information returned by the Server PSU through the first serial communication bus, it indicates that there is a normal communication between the BMC and the Server PSU. When the BMC receives the response information returned by the Server PSU through the second serial communication bus, it indicates that there is a fault on the first serial communication bus. In this case, the BMC and the Server PSU perform working communication or exchange bilateral bidirectional communication through the second serial communication bus.

In some embodiments, the determining at least one server power supply unit according to the query instruction, and transmitting an access request to the at least one server power supply unit through a first serial communication bus and the third switch includes:
transmitting a clock signal of the access request to the at least one server power supply unit through a first clock line in the first serial communication bus and the third clock line switch; and
transmitting a data signal of the access request to the at least one server power supply unit through a first data line in the first serial communication bus and the third data line switch.

In some embodiments, as shown in FIG. 2, when the BMC performs normal communication with the PSU through the first serial communication bus, the BMC transmits a data signal corresponding to the access request to the PSU by controlling its SDA out switch (the third data line switch) and the first SDA, and transmits a clock signal corresponding to the access request by controlling its SCL out switch (the third clock line switch) and the first SCL.

In some embodiments, the performing exchange bilateral bidirectional communication or the working communication with the at least one server power supply unit through the second serial communication bus and the third switch includes:
in response to receiving a clock signal of the response information through a second clock line in the second serial communication bus and a data signal of the response information through a second data line in the second serial communication bus, performing the working communication through the second serial communication bus and the third switch; and
in response to receiving the data signal through the second clock line in the second serial communication bus and the clock signal through the second data line in the second serial communication bus, performing the exchange bilateral bidirectional communication through the second serial communication bus and the third switch.

In some embodiments, as mentioned above, when the BMC receives the data signal of the response information through the second SDA and receives the clock signal of the response information through the second SCL, if the BMC needs to obtain the power information again within the system polling cycle, the BMC transmits the data signal of the access request through the second SDA in the second serial communication bus and transmits the clock signal of the access request through the second SCL in the second serial communication bus. That is, the working communication is performed. When the BMC receives the clock signal of the response information through the second SDA and receives the data signal of the response information through the second SCL, if the BMC needs to obtain the power information again within the system polling cycle, the BMC transmits the data signal of the access request through the second SDA and transmits the clock signal of the access request through the second SCL. That is, the exchange bilateral bidirectional communication is performed.

In some embodiments, the performing the exchange bilateral bidirectional communication through the second serial communication bus and the third switch includes:
in response to receiving a query instruction transmitted by the server system again, determining at least one server power supply unit according to the query instruction, and transmitting the data signal of the access request through the second clock line in the second serial communication bus and the third data line switch; and
transmitting the clock signal of the access request through the second data line in the second serial communication bus and the third clock line switch.

In some embodiments, as shown in FIG. 15, in the previous instance, the BMC transmits the access request to the PSU through the first serial communication bus, the SDA out switch, and the SCL out switch, and the PSU returns the response information to the BMC through the exchange bilateral bidirectional communication. If the BMC receives the query instruction again within a query cycle set by a user, the BMC also transmits the access request to the PSU again through the exchange bilateral bidirectional communication. The BMC controls its own SDA out switch (the third data line switch) to act and transmits the data signal corresponding to the access request to the PSU through the second SCL, and controls its own SCL out switch (the third clock line switch) to act and transmits the clock signal corresponding to the access request to the PSU through the second SDA. Correspondingly, in this case, the PSU returns the clock signal to the BMC through the second SDA and by controlling Q₃ to act, and returns the data signal to the BMC through the second SCL and by controlling Q₄ to act. In addition, as mentioned above, when the BMC and the PSU perform the working communication through the second serial communication bus, the BMC still controls its own SDA out switch (the third data line switch) to act and transmits the data signal corresponding to the access request to the PSU through the second SCL, and controls its own SCL out switch (the third clock line switch) and transmits the clock signal corresponding to the access request to the PSU through the second SDA. Differently, in this case, the PSU uses the second SDA and controls Q₁ to act to return the data signal to the BMC, and uses the second SCL and controls Q₂ to act to return the clock signal to the BMC.

In some embodiments, the method further includes:
in response to receiving communication abnormality information transmitted by the at least one server power supply unit through the second serial communication bus, alerting a user according to the communication abnormality information;
in response to receiving a normal communication restoration instruction transmitted by the user, transmitting a restart instruction to the at least one server power supply unit through the second serial communication bus and the third switch to restart the at least one server power supply unit; and
in response to completion of the restart of the at least one server power supply unit, performing the working communication through the first serial communication bus and the third switch.

In some embodiments, as mentioned above, when the BMC receives the communication abnormality information through the second serial communication bus, the BMC might transmit alert information to the server. Afterwards, the server alerts the user. After receiving the alert, the user checks remaining devices that are connected in series on the serial communication bus, solves the problem, and transmits the normal communication restoration instruction to the BMC through the server system. After receiving the instruction, the BMC transmits the restart instruction to the Server PSU through the second serial communication bus to restart the Server PSU. After the restart of the Server PSU is completed, the BMC and the Server PSU perform the working communication through the first serial communication bus. Specific steps will not be elaborated.

In some embodiments, a power information communication method applied to a power information communication system is further provided. The method includes:
in response to receiving a query instruction transmitted by a server system, determining, by a baseboard management controller, at least one server power supply unit according to the query instruction, and transmitting an access request to the at least one server power supply unit through a first serial communication bus;
in response to receiving the access request transmitted by the baseboard management controller through the first serial communication bus, returning, by the at least one server power supply unit, response information to the baseboard management controller through the first serial communication bus, where the first serial communication bus includes a first data line and a first clock line, and the at least one server power supply unit includes a group of first switches and a group of second switches;
determining, according to a polling cycle set by a user by the at least one server power supply unit, whether a working communication with the baseboard management controller is abnormal; and
if the working communication is abnormal, restoring, by the at least one server power supply unit and the baseboard management controller, communication through one of the first serial communication bus and a second serial communication bus, and one of the group of first switches and the group of second switches, where the second serial communication bus includes a second data line and a second clock line; the first clock line and the second clock line are connected in parallel to each other; and the first data line and the second data line are connected in parallel to each other.

In some embodiments, when the BMC transmits an access request to the Server PSU, the BMC transmits a data signal of the access request to the Server PSU through its internal SDA out switch and a first SDA, and transmits a clock signal of the access request to the Server PSU through its internal SCL out switch and a first SCL. When the Server PSU uses a second SDA and controls Q₁ to act to successfully return a data signal of the response information to the BMC, and uses a second SCL and controls Q₂ to act to successfully return a clock signal of the response information to the BMC, it indicates that there is a normal communication between the BMC and the Server PSU. If the Server PSU does not receive, within a polling cycle, the access request transmitted by the BMC, it is determined that there is a communication failure. Afterwards, the Server PSU may attempt to restore the working communication through the first serial communication bus, Q₁, and Q₂, the second serial communication bus, Q₁, and Q₂. If the two ways fail, the Server PSU performs exchange bilateral bidirectional communication with the BMC through the second serial communication bus, Q₃, and Q₄.

The solutions of the present application have the following beneficial effects:
1) Communication between the BMC and the Server PSU is continuously monitored through the Server PSU. When it is determined that a communication failure occurs, the corresponding switches are turned on first to continuously pull down the pin levels to attempt to restore the communication between the BMC and the Server PSU. Before the BMC sounds an alarm, the I2C Bus communication is actively restored, whereby maintenance personnel does not need to power off an input AC power supply unit of the Server PSU or does not need to replace the Server PSU to restore the communication with the system.
2) The exchange bilateral bidirectional communication is implemented through the other SDA and the other SCL that are connected in parallel to each other and by controlling the other SDA switch and the other SCL switch, thereby avoiding the communication failure caused by deadlock in the I2C bus.

It is understood that although all the steps in the flowchart of FIG. 4 are displayed in sequence according to the instructions of the arrows, these steps are not necessarily performed in sequence according to the sequence indicated by the arrows. Unless otherwise explicitly specified in the present disclosure, execution of the steps is not strictly limited, and the steps may be performed in other sequences. Moreover, at least some of the steps in FIG. 4 may include a plurality of substeps or a plurality of stages. These substeps or stages are not necessarily performed at the same moment but may be performed at different moments. Execution of these substeps or stages is not necessarily performed in sequence, but may be performed in turn or alternately with other steps or substeps in other steps or at least some of the stages.

In some embodiments, a power information communication system is further provided, including a baseboard management controller, at least one server power supply unit, a first serial communication bus, and a second serial communication bus.

Each of the at least one server power supply includes a group of first switches and a group of second switches, and the baseboard management controller includes a group of third switches.

Working communication is performed between the baseboard management controller and the at least one server power supply through the first serial communication bus, the third switches, and the first switches; working communication is performed between the baseboard management controller and the at least one server power supply unit through the second serial communication bus, the third switches, and the first switches; exchange bilateral bidirectional communication is performed between the baseboard management controller and the at least one server power supply unit through the second serial communication bus, the third switches, and the second switches; the first serial communication bus includes a first data line and a first clock line; the second serial communication bus includes a second data line and a second clock line; the first clock line and the second clock line are connected in parallel to each other; and the first data line and the second data line are connected in parallel to each other.

In some embodiments, the system further includes:
the first switches include a first data line switch and a first clock line switch; the first data line switch is configured to adjust pin levels of the first data line and the second data line; the first clock line switch is configured to adjust pin levels of the first clock line and the second clock line; the second switches include a second data line switch and a second clock line switch; the second data line switch is configured to adjust a pin level of the second clock line, and the second clock line switch is configured to adjust a pin level of the second data line; the third switches include a third data line switch and a third clock line switch; the third data line switch is configured to adjust the pin levels of the first data line and the second clock line; and the third clock line switch is configured to adjust the pin levels of the first clock line and the second data line.

In some embodiments, a computer device is provided. The computer device may be a terminal, a diagram of an internal structure of which might be as shown in FIG. 21. The computer device includes a processor, a memory, a network interface, a display screen, and an input apparatus which are connected through a system bus. The processor of the computer device is configured to provide computing and control capabilities. The memory of the computer device includes a non-transitory storage medium and an internal memory. The non-transitory storage medium stores an operating system and a computer-readable instruction. The internal memory provides an environment for running the operating system and the computer-readable instruction in the non-transitory storage medium. The network interface of the computer device is used for communicating with an external terminal through network connection. The computer-readable instruction is executed by the processor to implement an alert information processing method. The display screen of the computer device may be a liquid crystal display screen or an e-ink display screen. The input apparatus of the computer device may be a touch layer covering the display screen, or may be a button, a trackball, or a touchpad arranged on a housing of the computer device, or may be an external keyboard, touchpad, a mouse or the like.

A person skilled in the art might understand that the structure shown in FIG. 21 is merely a block diagram of a partial structure related to a solution in this application, and does not constitute a limitation on the computer device to which the solution in this application is applied. In some embodiments, the computer device may include more or fewer components than those shown in the figure, or some components may be combined, or a different component layout may be used.

In some embodiments, an electronic device is provided, which includes a memory, a processor, and a computer-readable instruction stored on the memory and executable on the processor. The processor, when executing the computer-readable instruction, implements the method according to any one or more embodiments described above.

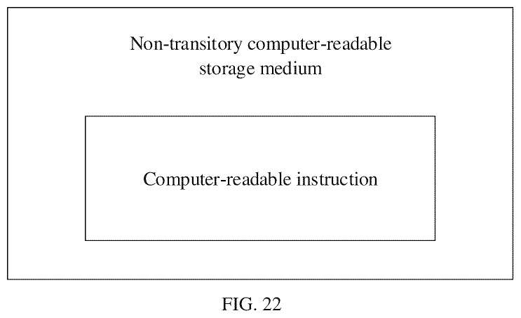

In some embodiments, as shown in FIG. 22, a non-transitory computer-readable storage medium is provided, having a computer-readable instruction stored thereon. The computer-readable instruction, when executed by a processor, implements the method according to any one or more embodiments described above.

A person of ordinary skill in the art may understand that all or some of the procedures of the method in the foregoing embodiments may be implemented by the computer-readable instructions that instruct relevant hardware. The computer-readable instructions may be stored in a non-transitory computer-readable storage medium. When the computer-readable instructions are executed, the procedures of the foregoing method embodiments may be implemented. Any reference to the memory, the database, or other media used in the embodiments provided in the present application might include a non-transitory memory and/or a volatile memory. The non-transitory memory may include a read-only memory (ROM), a programmable ROM (PROM), an electrically programmable ROM (EPROM), an electrically erasable programmable ROM (EEPROM), or a flash memory. The volatile memory might include a random access memory (RAM) or an external cache memory. As an illustration, but not a limitation, the RAM might be obtained in various forms, such as a static RAM (SRAM), a dynamic RAM (DRAM), a synchronous DRAM (SDRAM), a double data rate SDRAM (DDRSDRAM), an enhanced SDRAM (ESDRAM), a synchlink DRAM (SLDRAM), a rambus direct RAM (RDRAM), a direct memory bus dynamic RAM (DRDRAM), and a memory bus dynamic RAM (RDRAM).

All the technical features of the above embodiments might be combined randomly. For the sake of brevity, all possible combinations of all the technical features in the above embodiments are not described. However, these technical features shall all be considered to fall within the scope of this specification as long as there is no contradiction in their combinations.

The foregoing embodiments merely express several implementations of the present disclosure. The descriptions thereof are relatively specific and detailed, but are not understood as limitations on the scope of the present disclosure. A person of ordinary skill in the art might also make several transformations and improvements without departing from the idea of the present disclosure. These transformations and improvements fall within the protection scope of the present disclosure. Therefore, the protection scope of the patent of present disclosure shall be subject to the appended claims.

1. A power information communication method, being applied to at least one server power supply unit, wherein the at least one server power supply unit comprises a first switch and a second switch; the first switch comprises a first clock line switch and a first data line switch; the second switch comprises a second clock line switch and a second data line switch; and the method comprises:
in response to receiving an access request transmitted by a baseboard management controller through a first serial communication bus, returning response information to the baseboard management controller through the first serial communication bus, wherein the first serial communication bus comprises a first data line and a first clock line;
determining, according to a polling cycle set by a user, whether a working communication with the baseboard management controller is abnormal; and
in response to an abnormal working communication with the baseboard management controller, restoring communication with the baseboard management controller through one of the first serial communication bus and a second serial communication bus, and one of the first switch and the second switch, wherein communications between the at least one server power supply unit and the baseboard management controller comprise a working communication or an exchange bilateral bidirectional communication, and the second serial communication bus comprises a second data line and a second clock line; the first clock line and the second clock line are connected in parallel to each other; and the first data line and the second data line are connected

2. The method according to claim 1, wherein the determining, according to a polling cycle set by a user, whether a working communication with the baseboard management controller is abnormal comprises:
in response to monitoring that a pin level of the first data line and a pin level of the first clock line are both high levels, determining whether the access request is received within the polling cycle;
in response to receiving the access request within the polling cycle, returning the response information to the baseboard management controller through the first serial communication bus; and
in response to not receiving the access request within the polling cycle, determining that the working communication is abnormal.

3. The method according to claim 1, wherein the restoring communication with the baseboard management controller through one of the first serial communication bus and a second serial communication bus, and one of the first switch and the second switch comprises:
attempting to restore the working communication through the first serial communication bus, the first data line switch corresponding to the first data line, and the first clock line switch corresponding to the first clock line;
in response to a failure of attempting to restore the working communication through the first serial communication bus, the first data line switch, and the first clock line switch, attempting to restore the working communication through the second serial communication bus, the first data line switch, and the first clock line switch; and
in response to a failure of attempting to restore the working communication through the second serial communication bus, the first data line switch, and the first clock line switch, performing the exchange bilateral bidirectional communication with the baseboard management controller through the second serial communication bus, the second data line switch, and the second clock line switch.

4. The method according to claim 3, wherein the attempting to restore the working communication through the first serial communication bus, the first data line switch, and the first clock line switch comprises:
turning on the first data line switch according to a time threshold set by the user to continuously pull down a pin level of the first data line to a low level, and turning on the first clock line switch to continuously pull down a pin level of the first clock line to the low level;
determining whether the access request transmitted by the baseboard management controller is received through the first serial communication bus within the polling cycle;
in response to receiving the access request transmitted by the baseboard management controller, returning the response information to the baseboard management controller through the first serial communication bus; and
in response to not receiving the access request transmitted by the baseboard management controller, continuing to attempt to restore the working communication according to a number-of-times threshold and the first serial communication bus.

5. The method according to claim 4, wherein the returning the response information to the baseboard management controller through the first serial communication bus comprises:
returning a clock signal corresponding to the response information through the first clock line in the first serial communication bus and the first clock line switch; and
returning a data signal corresponding to the response information through the first data line in the first serial communication bus and the first data line switch.

6. The method according to claim 3, wherein the attempting to restore the working communication through the second serial communication bus, the first data line switch, and the first clock line switch comprises:
turning on the first data line switch according to a time threshold to continuously pull down a pin level of the second data line to a low level, and turning on the first clock line switch to continuously pull down a pin level of the second clock line to the low level;
determining whether the access request transmitted by the baseboard management controller is received through the second serial communication bus within the polling cycle;
in response to receiving the access request transmitted by the baseboard management controller, returning the response information to the baseboard management controller through the second serial communication bus; and
in response to not receiving the access request transmitted by the baseboard management controller, continuing to attempt to restore the working communication according to a number-of-times threshold and the second serial communication bus.

7. The method according to claim 6, wherein the returning the response information to the baseboard management controller through the second serial communication bus comprises:
returning a clock signal corresponding to the response information through the second clock line in the second serial communication bus and the first clock line switch; and
returning a data signal corresponding to the response information through the second data line in the second serial communication bus and the first data line switch.

8. The method according to claim 3, wherein the performing the exchange bilateral bidirectional communication with the baseboard management controller through the second serial communication bus, the second data line switch, and the second clock line switch comprises:
turning on the second data line switch according to a time threshold to continuously pull down a pin level of the second clock line to a low level, and turning on the second clock line switch to continuously pull down a pin level of the second data line to the low level; and
in response to receiving the access request transmitted by the baseboard management controller, returning the response information to the baseboard management controller through the second serial communication bus, the second data line switch, and the second clock line switch.

9. The method according to claim 8, wherein the returning the response information to the baseboard management controller through the second serial communication bus, the second data line switch, and the second clock line switch comprises:
returning a data signal corresponding to the response information through the second clock line in the second serial communication bus and the second data line switch; and
returning a clock signal corresponding to the response information through the second data line in the second serial communication bus and the second clock line switch.

10. The method according to claim 8, wherein after the returning the response information to the baseboard management controller through the second serial communication bus, the second data line switch, and the second clock line switch, the method further comprises:
generating communication abnormality information, and transmitting the communication abnormality information to the baseboard management controller through the second serial communication bus, the second data line switch, and the second clock line switch;
in response to receiving a restart instruction transmitted by the baseboard management controller, restarting an input power supply unit according to the restart instruction to turn off the second data line switch and the second clock line switch; and
in response to restarting the input power supply unit, performing the working communication through the first serial communication bus, the first data line switch, and the first clock line switch.

11. A power information communication method, being applied to a baseboard management controller, wherein the baseboard management controller comprises a third switch; the third switch comprises a third clock line switch and a third data line switch; and the method comprises:
in response to receiving a query instruction transmitted by a server system, determining at least one server power supply unit according to the query instruction, and transmitting an access request to the at least one server power supply unit through a first serial communication bus and the third switch;
in response to receiving response information returned by the at least one server power supply unit through the first serial communication bus, performing working communication with the at least one server power supply unit through the first serial communication bus and the third switch; and
in response to receiving the response information returned by the at least one server power supply unit through a second serial communication bus, performing exchange bilateral bidirectional communication or the working communication with the at least one server power supply unit through the second serial communication bus and the third switch, wherein communications between the at least one server power supply unit and the baseboard management controller comprise the working communication or the exchange bilateral bidirectional communication.

12. The method according to claim 11, wherein the determining at least one server power supply unit according to the query instruction, and transmitting an access request to the at least one server power supply unit through a first serial communication bus and the third switch comprises:
transmitting a clock signal of the access request to the at least one server power supply unit through a first clock line in the first serial communication bus and the third clock line switch; and
transmitting a data signal of the access request to the at least one server power supply unit through a first data line in the first serial communication bus and the third data line switch.

13. The method according to claim 11, wherein the performing exchange bilateral bidirectional communication or the working communication with the at least one server power supply unit through the second serial communication bus and the third switch comprises:
in response to receiving a clock signal of the response information through a second clock line in the second serial communication bus and a data signal of the response information through a second data line in the second serial communication bus, performing the working communication through the second serial communication bus and the third switch; and
in response to receiving the data signal through the second clock line in the second serial communication bus and the clock signal through the second data line in the second serial communication bus, performing the exchange bilateral bidirectional communication through the second serial communication bus and the third switch.

14. The method according to claim 13, wherein the performing the exchange bilateral bidirectional communication through the second serial communication bus and the third switch comprises:
in response to receiving the query instruction transmitted by the server system again, determining at least one server power supply unit according to the query instruction, and transmitting the data signal of the access request through the second clock line in the second serial communication bus and the third data line switch; and
transmitting the clock signal of the access request through the second data line in the second serial communication bus and the third clock line switch.

15. The method according to claim 11, further comprising:
in response to receiving communication abnormality information transmitted by the at least one server power supply unit through the second serial communication bus, alerting a user according to the communication abnormality information;
in response to receiving a normal communication restoration instruction transmitted by the user, transmitting a restart instruction to the at least one server power supply unit through the second serial communication bus and the third switch to restart the at least one server power supply unit; and
in response to completion of the restart of the at least one server power supply unit, performing the working communication through the first serial communication bus and the third switch.

16. (canceled)

17. A power information communication system, comprising a baseboard management controller, at least one server power supply unit, a first serial communication bus, and a second serial communication bus,
wherein each of the at least one server power supply comprises a group of first switches and a group of second switches; the baseboard management controller comprises a group of third switches; and
working communication is performed between the baseboard management controller and the at least one server power supply through the first serial communication bus, the third switches, and the first switches; the working communication is performed between the baseboard management controller and the at least one server power supply unit through the second serial communication bus, the third switches, and the first switches; exchange bilateral bidirectional communication is performed between the baseboard management controller and the at least one server power supply unit through the second serial communication bus, the third switches, and the second switches; the first serial communication bus comprises a first data line and a first clock line; the second serial communication bus comprises a second data line and a second clock line; the first clock line and the second clock line are connected in parallel to each other; and the first data line and the second data line are connected in parallel to each other.

18. The system according to claim 17, wherein,
the first switches comprise a first data line switch and a first clock line switch; the first data line switch is configured to adjust pin levels of the first data line and the second data line; the first clock line switch is configured to adjust pin levels of the first clock line and the second clock line;
the second switches comprise a second data line switch and a second clock line switch; the second data line switch is configured to adjust a pin level of the second clock line, and the second clock line switch is configured to adjust a pin level of the second data line; and
the third switches comprise a third data line switch and a third clock line switch; the third data line switch is configured to adjust the pin levels of the first data line and the second clock line; and the third clock line switch is configured to adjust the pin levels of the first clock line and the second data line.

19. A computer device, comprising a memory, a processor, and a computer-readable instruction stored on the memory and executable on the processor, wherein the processor, when executing the computer-readable instruction, is configured to implement the method according to claim 1.

20. A non-transitory computer-readable storage medium, having a computer-readable instruction stored thereon, wherein the computer-readable instruction, when executed by a processor, is configured to implement the method according to claim 1.

21. (canceled)

22. A power information communication method applied to the power information communication system according to claim 17, comprising:
in response to receiving a query instruction transmitted by a server system, determining, by the baseboard management controller, the at least one server power supply unit according to the query instruction, and transmitting an access request to the at least one server power supply unit through the first serial communication bus;
in response to receiving the access request transmitted by the baseboard management controller through the first serial communication bus, returning, by the at least one server power supply unit, response information to the baseboard management controller through the first serial communication bus;
determining, according to a polling cycle set by a user by the at least one server power supply unit, whether the working communication with the baseboard management controller is abnormal; and
in response to an abnormal working communication with the baseboard management controller, restoring, by the at least one server power supply unit and the baseboard management controller, communication through one of the first serial communication bus or the second serial communication bus, and one of the group of first switches or the group of second switches, wherein communications between the at least one server power supply unit and the baseboard management controller comprise the working communication or the exchange bilateral bidirectional communication.
